(19) United States
(12) Patent Application Publication
(10) Pub. No.: US 2004/0036305 A1
(43) Pub. Date: Feb. 26, 2004

(54) Retractable grab handle

(76) Inventors: Gregory D. Smith, Carmel, IN (US); Guy R. Dingman, Westfield, IN (US); David D. Merrick, Cicero, IN (US); William D. Dodson, Lebanon, IN (US)

Correspondence Address: BARNES & THORNBURG, 11 SOUTH MERIDIAN, INDIANAPOLIS, IN, 46204

(21) Appl. No.: 10/618,858

(22) Filed: Jul. 14, 2003

Related U.S. Application Data
(60) Provisional application No. 60/395,833, filed on Jul. 14, 2002.

(51) Int. Cl. B60N 3/02

(52) U.S. Cl. 296/1.02

(57) ABSTRACT

A stabilizing device comprises a flexible member coupled at one end to a handgrip and at the other end to a retraction mechanism, which tends to urge the flexible member in a retraction direction. The retraction mechanism may operate linearly or rotationally. A user is stabilized by grasping and pulling the handgrip in an extension direction opposite the retraction direction.

This application claims priority to and the benefit of U.S. Provisional Application No. 60/395,833, filed 14 July 2002.

### BACKGROUND AND SUMMARY OF THE INVENTION

The present invention relates generally to stabilizing devices and more particularly to a stabilizing device having a retractable handle.

Various systems are used to restrain or provide stability to a user, such as an occupant of a vehicle. For example, some restraint systems are attached to a vehicle seat and may include various shoulder belts or shoulder belt portions which extend over an occupant's shoulders, lap belts or lap belt portions which extend over an occupant's lap when restrained, and/or other belt portions coupled to a seat bottom of the vehicle seat. Also, various other stabilizing devices are used on vehicles or structures. For example, some vehicles have non-retractable handles rigidly mounted to the ceiling or wall of the vehicle for an occupant to hold onto for stability. Similarly, some buildings have handles or bars attached to the wall to assist occupants in rising from a seated or prone position, or in maintaining a standing position.

The present invention comprises one or more of the features or combinations thereof set out in the claims and herein. A vehicle or a building may be equipped with a restraint or a stabilizing device. The stabilizing device comprises a grab handle having a handgrip and a retraction mechanism coupled to the grab handle by a flexible member. The flexible member may be for example, without limitation a web, a belt, a rope, a line, a cable, plastic, cloth or other suitable flexible member. The retraction mechanism, which may be a linear or a rotational retractor, normally applies to the flexible member a retraction force to urge the flexible member into a retracted position and the grab handle into a stowed position. In the stowed position, the grab handled is nestled in a storage cavity defined in a mounting or faceplate attached to the stabilizing device. The mounting plate may be attached directly to the stabilizing device, or may be attached to an intervening wall, or both.

A user may apply to the handgrip an extension force sufficient to overcome the retraction force in an extension direction away from the stabilizing device, as for example by pulling the grab handle outwardly, downwardly, or upwardly away from the mounting plate, in order to move the flexible member into the extended position. Upon releasing the grab handle the retraction mechanism returns to its normal state and again exerts the retraction force on the flexible member in the retraction direction to return it to the retracted position, and the grab handle to the retracted or stowed position. Short of releasing the retractable grab handle, however, the outward force applied thereto may be eased to less than the retraction force such that the flexible member will retract or be drawn in the retraction direction until such time as an extension force equal to or greater than the retraction force is reapplied to maintain or increase, respectively, the degree of extension. By applying an extension force generally equal to the retraction force, or greater than the retraction force such that the extension member is fully extended, the user may be stabilized by the resistance opposing further extension.

The retraction mechanism, may be a linear mechanism or a rotary mechanism. A child seat is equipped with a five-point restraint system comprising a restraint harness or assembly, a buckle, one or more tongues, an automatic retractor and a manual tensioning device. The restraint harness comprises a pair of lap and shoulder portions, and a retraction portion, and may be any flexible member such as a web, a rope, a belt and the like. The buckle is attached to the seat and the tongues are movably disposed on the restraint harness and are lockingly and releasably engageable with the buckle to construct the five-point restraint. In the alternative, a pair of buckles may be movably disposed on the restraint harness and a tongue may be attached to the seat for releasably engagement.

In the case of a linear mechanism, the retractor mechanism comprises at least one slider member or bar, biased by a pair of spaced apart bias members, which may be springs, for example. The flexible member is disposed at least partially about the slider member, which is normally urged by the bias members to retract the flexible member into the retracted position, which is generally defined by a linear and serpentine path. Applying the extension force straightens the flexible member from the serpentine path, thereby allowing extension of the flexible member into the extended position or a position intermediate thereto. In the case of a rotary mechanism, the retractor mechanism comprises a spool, which may have ratchet wheels or flanges at each end thereof, movably mounted to a frame. A spool bias member, which may be a spring for example, is disposed between the spool and the frame and tends to urge the spool to move in a retraction direction to wind up the flexible member into the retracted position. Applying an adequate extension force to the flexible member allows the flexible member to pay out into the extended position, or a position intermediate thereto.

These and other features of the present invention will become more apparent from the following description of the illustrative embodiments exemplifying the best mode of carrying out the invention as presently perceived.

### BRIEF DESCRIPTION OF THE DRAWINGS

The detailed description particularly refers to the accompanying figures in which:

FIG. 1 is a perspective view of one illustrative embodiment of the present invention showing a stabilizing device with its handle in a retracted position and with a partial cut-away of its front surface.

FIG. 2 is a partial rear perspective view of the illustrative embodiment of FIG. 1 with the housing surfaces omitted.

FIG. 3 is a partial perspective view of the illustrative embodiment of FIG. 2 showing its handle in an extended position.

FIG. 4 is a sectional view of the illustrative embodiment of FIG. 1 taken generally along the line 4-4 and showing the handle in a generally extended position.

FIG. 5 is a perspective view of another illustrative embodiment of the present invention showing a grab handle device with its handle in a retracted position.

FIG. 6. is a side elevation of the illustrative embodiment of FIG. 5.

FIG. 7 is an end view of the illustrative embodiment of FIG. 5 showing a slider member in its steady-state position.

FIG. 8 is an exploded view of the illustrative embodiment of FIG. 5.

FIG. 9 is a perspective view of another illustrative embodiment.

FIG. 10 is an end view of the illustrative embodiment of FIG. 9.

FIG. 11 is an exploded view of another illustrative embodiment of a retractable handle incorporating a rotary retraction device.

FIG. 12 is a perspective view of the illustrative embodiment of FIG. 11.

FIG. 13 is a partial view showing the illustrative embodiment of FIG. 11 operatively mounted to a vehicle.

FIG. 14 is a diagrammatic view showing the illustrative embodiments of FIGS. 1-12 mounted on a golf cart.

FIG. 15 is a diagrammatic view showing the illustrative embodiment of FIG. 1 or FIG. 5 mounted to a vehicle.

### DETAILED DESCRIPTION OF THE DRAWINGS

For the purposes of promoting an understanding of the principles of the invention, reference will now be made to an illustrative embodiment depicted in the drawings in which like numerals are employed to designate like parts throughout and specific language will be used to describe the illustrative embodiment. It will nevertheless be understood that no limitation of the scope of the invention is thereby intended. An illustrative retractable restraint or stabilizing device 10 is provided for use with a vehicle 54 or other structure. Retractable grab handle stabilizing device 10 is movable by a user between a retracted and stowed position, and an extended and stabilizing position.

Illustratively, the retractable stabilizing device 10 comprises a handgrip 12, a flexible extension member 20, a linear retraction mechanism 30, an housing 60, and a mounting or face plate 78. As best seen in FIG. 3, handgrip 12 is a generally T-shaped, monolithic piece of injection molded plastic having a grip portion 14, an elongated neck portion 15, and a coupling portion 16. Coupling portion 16 is generally rectangular in shape and has an anchor bar 19 extending between and generally perpendicular to spaced-apart parallel ears 17 and 18 forming anchor aperture 29. It will be appreciated that although the grip portion 14, the neck portion 15 and the coupling portion 16 are fashioned from a single piece of injection molded plastic, it could be fashioned from other suitable materials and methods of manufacture. For example, it could be die-cast from a suitable metal, such as aluminum or zinc. Similarly, it could be extruded. Other suitable materials include other metallic, nonmetallic, composite materials, and/or combinations thereof, including for example graphite or kevlar. Also, rather than being a monolithic member, the handgrip 12 could comprise a number of discrete component pieces coupled together in ways known to those in the art. For example, the anchor bar 19 could be coupled to the ears 17, 18 using screws (not shown).

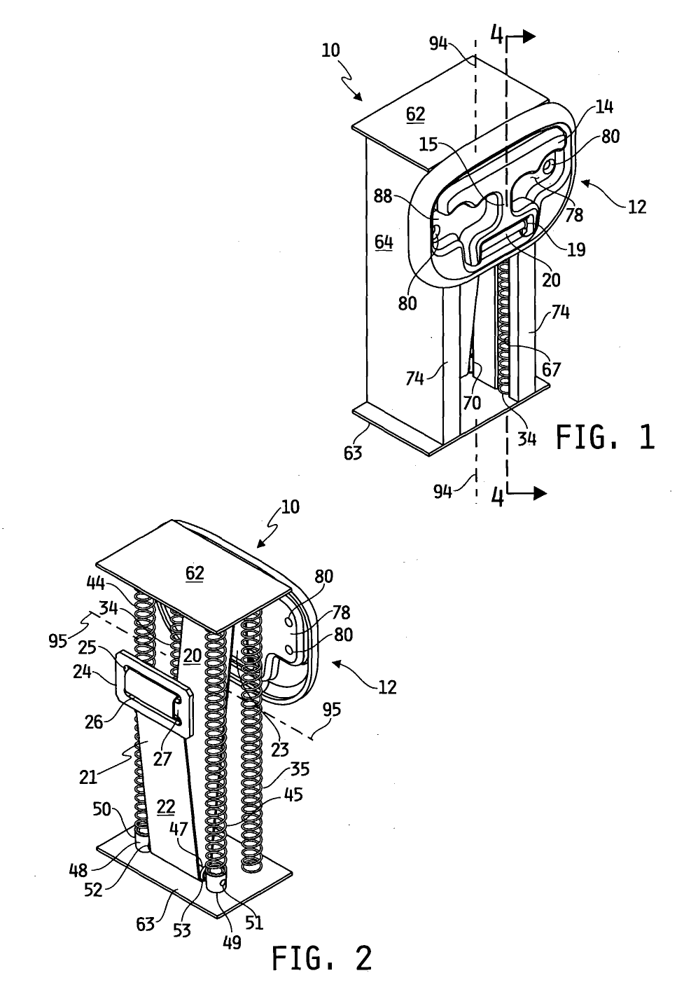

Illustratively, extension or flexible member 20 is movably coupled to the anchor bar 19. In the illustrative embodiments shown in FIGS. 1-4, extension member 20 is a flexible member having opposing end portions 21 and 23 and a mid-portion 22 therebetween. Extension member 20 may be a length of web belt, a length of line, a length of cable, a length of rope, a length of plastic, a length of cloth or other suitable flexible material. Handgrip 12 may move relative to extension member 20 about anchor bar's 19 longitudinal axis. End portion 21 is generally proximate to housing 60 and is anchored thereto by anchorage or anchor member 24 or other suitable anchorage. Anchor member 24, illustratively, is generally rectangular in shape having an elongated cross-bar 27 defining a pair of parallel and spaced apart apertures 25 and 26. End portion 21 is threaded through aperture 25, around cross-bar 27, through aperture 26, and back on itself for coupling. End portion 23 is generally proximate to handgrip 12 and is threaded around anchor bar 19 through anchor aperture 29 and back over on itself for coupling. The end portions 21, 23 may be coupled, or secured, using couplings suitable to the particular type of flexible member in use. For example, in the case of webbing, the ends 21, 23 may be coupled by stitching, snaps, hook and loops, cement, melting or other suitable coupling. By way of further example, in the case of a rope or line, coupling may be accomplished through splicing or wrapping, and in the case of a cable, coupling may be accomplished through splicing, wrapping or welding, and the like.

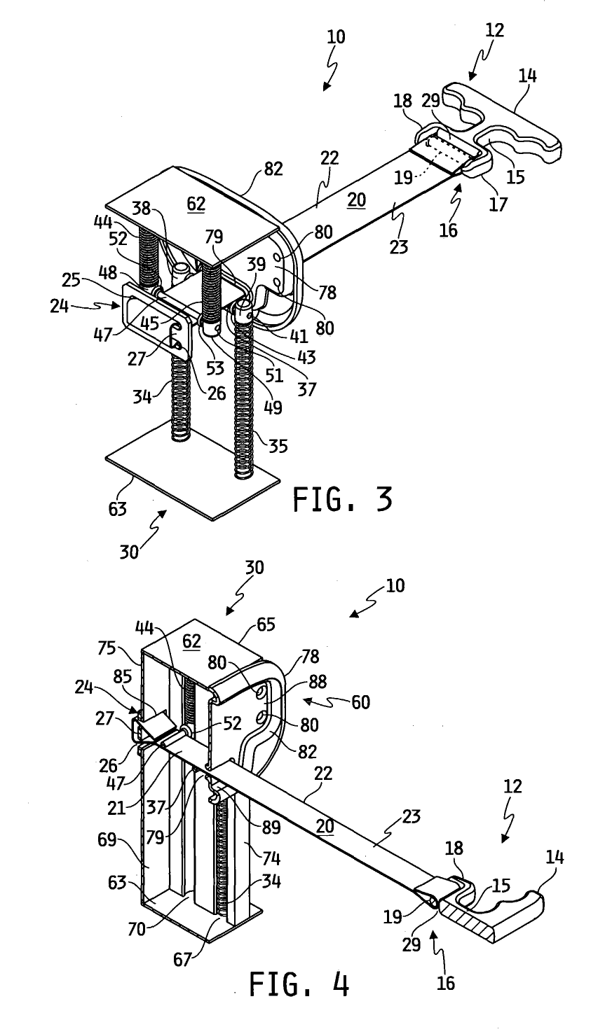

Referring to FIGS. 1 and 4, housing 60 is generally rectangular in cross-section having a longitudinal axis 94 and a transverse axis 95 (FIG. 2), which is generally perpendicular to the longitudinal axis 94. Housing 60 includes spaced apart and generally parallel front 62 and rear 63 surfaces, spaced apart and generally parallel side surfaces 64 and 65, and spaced apart and generally parallel front 74 and rear 75 surfaces. Front surface 74 defines guide aperture 79. Rear surface 75 defines anchor aperture 85. Front and rear surfaces 74 and 75 define a longitudinally extending channel or cavity 69 in which the extension member 20 lies and moves. The coupling of end portion 21 described above may be located between anchor member 24 and rear surface 75, inside aperture 85, or anywhere between rear surface 75 and anchor bar 19. Similarly, the coupling of end portion 23 may be located anywhere along the length of extension member 20. Further coupling options will be described below. As will also be explained further below, side surface 65 includes a pair of spaced-apart and generally parallel and longitudinally extending guide channels 67 and 70. Side surface 64 includes a corresponding pair of spaced-apart and generally parallel and longitudinally extending guide channels (not shown).

Mounting plate 78 is a single piece of injection molded plastic defining a storage cavity 88 bounded generally by lip or ridge 82 and having a guide aperture 89 and a plurality of coupling apertures 80 formed therethrough. The storage cavity 88 is configured to receive and nestle the handgrip 12 in the retracted position. Coupling apertures 80 are configured to receive any suitable fastener, which, may comprise without limitation, for example, screws, rivets, nuts and bolts, press fits, and the like or any combination thereof, to fasten the mounting plate 78 to the front surface 74 of the housing 60 such that guide apertures 79 and 89 are generally aligned. It will be appreciated, however, that the mounting plate 78 could be mounted directly to an intervening surface, such as for example a wall, of a vehicle or a building. The vehicle wall may be, for example, a side wall, or the wall 58 below the seat portion 56 of a seat 55. Whether in a building or a vehicle, the wall would have an aperture (not shown) generally aligned with apertures 79 and 89, and the mounting plate 78 could be mounted directly to the wall (not shown) or to both the wall and the front surface 74. However, it is also within the teaching of the disclosure to eliminate the front surface 74 and to attach the surfaces 62, 63, 64, 65 of the housing 60 directly to a side of the wall (not shown) and the mounting plate to an opposite side of the wall (not shown) with the wall's guide aperture being generally aligned with the guide aperture 89.

As best seen in FIG. 4, extension member 20 extends away from handgrip 12 and passes through guide aperture 89, through guide aperture 79, between slider members or bars 37 and 47 and through anchor aperture 85 and anchor member 24 as previously described. Illustratively, it will be appreciated that a single coupling may be made as, for example, where the flexible extension member 20 is a single length of web doubled back on itself and coupled as described above to form an endless belt. In such a case, for example, the web could pass around cross bar 27 with one portion passing through aperture 25 and away therefrom and another portion passing through aperture 26 and away therefrom and back underneath the one portion of itself, with each portion proceeding in such overlapping manner through each aperture 85, 79, 89 and toward anchor bar 19 and through aperture 29. At any point along the length of such a web, the opposing ends, or at one or more other points along the overlapping length of web, could be coupled together by stitching, hooks and loops, snaps, cement, glue, tacking, zippers, and the like.

Referring to FIGS. 2-4, the retraction mechanism 30 comprises a pair of spaced apart and generally parallel slider bars 37 and 47, each biased in opposition to the other by a pair of respective spaced-apart springs 34, 35 and 44, 45. The slider bars 37, 47 illustratively are made of injection molded plastic and include respective coupling portions 38, 39 and 48, 49 and respective guide portions 42, 43 and 52, 53. Coupling portions 38, 39 couple slider bar 37 to springs 34, 35 using fasteners 41 and lie within channels 67 and 70 (FIGS. 1-4). Similarly, coupling portions 48, 49 couple slider bar 47 to springs 44, 45 using fasteners 51 and lie within the channels of the side surface 65. The guide portions 42, 43, 52, 53 lie outside the respective channels, but within the cavity 69. As can best be seen in FIGS. 1 and 4, channels 67 and 70 are configured to receive, respectively, springs 34 and 44. Similarly, the channels (not shown) defined by surface 64 are configured to receive, respectively, springs 35 and 45. The springs 34, 35, 44, 45 generally are aligned with longitudinal axis 94 within their respective channels and are made of a metallic material, such as, for example, stainless steel. Of course, the springs could be fashioned out of other suitably resilient materials. The coupling portions 38, 39, 48, 49 and the guide portions 42, 43, 52, 53 are configured to align and guide the springs 34, 35 and 44, 45 within their respective channels 67, 70. The ends of the springs 34, 35 distal from coupled slider bar 37 are coupled to bottom surface 63. The ends of springs 44, 45 distal from coupled slider bar 47 are coupled to top surface 62.

In operation, springs 34, 35 in their normal, at-rest or steady state position bias slider bar 37 upwardly away from bottom surface 63 and anchorage 24 and toward top surface 62 and springs 44, 45 normally bias slider bar 47 downwardly away from top surface 62 and anchorage 24 and toward bottom surface 63. It will be appreciated that other suitable biasing structures, such as rubber bands, hydraulic pistons, pneumatic pistons and the like could be used to bias the bars 37, 47. In this normal state, handgrip 12 is stowed within cavity 88 and the flexible member 20 is generally withdrawn or retracted within the housing 60 in cavity 69. In this normal state, as best seen in FIG. 2, extension member 20 passes underneath and at least partially around slider bar 47, which, at the urging of springs 44 and 45, forces the middle portion 22 proximate to end portion 21 downwardly toward bottom surface 63, with the end portion 21 then proceeding upwardly away therefrom toward anchorage 24. Similarly, belt 20 passes over and at least partially around slider bar 37, which at the urging of springs 34 and 35, forces the middle portion 22 proximate to end portion 23 upwardly toward top surface 62, with the end portion 23 then proceeding downwardly away therefrom toward apertures 89, 79 and then at least partially around anchor bar 19 as previously described. Thus, in the normal or steady-state configuration, the oppositely biased spring pairs 34, 35 and 44, 45 cooperate to bias the slider bars to urge the flexible member 20 into a retracted position generally defined by a substantially longitudinally oriented and serpentine path in order to retract into the cavity and to retain or stow therein in a stowed position the handgrip 12.

As best seen in FIGS. 3 and 4, when a user of the stabilizing grab handle device 10 applies to the handgrip 12 an extension force sufficient to overcome the bias force of the springs 34, 35, 44, 45 in an extension direction away from the stabilizing device 10, as for example by pulling the gripping portion 14 outwardly, downwardly, or upwardly away from the mounting plate 78, the flexible extension member 20 acts against the spring-biased slider bars 37, 47 to urge the two bars toward each other and generally in line with the apertures 85, 89, 79, which straightens the member 20 and pays it out of the housing 60 into the extended position. As the flexible extension member 20 extends and pulls the bars in opposing directions, the springs compress in their respective channels and the slider members or bars 37, 47 translate in a generally linear fashion within the channels 67, 70 (and not shown). Upon releasing the gripping portion 14, the springs 34, 35, 44, 45 return to their normal state and urge their respective bars 37, 47, and in turn the handgrip 10 and flexible extension member 20, in the retraction direction back to the retracted and stowed positions. Short of releasing the handgrip 12, the outward force applied thereto may be eased to less than the bias forces of the springs 34, 35, 44, 45 such that the belt 20 will retract or be drawn in the retraction direction until such time as an outward force equal to or greater than the retraction bias force is reapplied to maintain or increase, respectively, the degree of extension. By applying an extension force generally equal to the retraction force, or greater than the retraction force such that the extension member 20 is fully extended, the user may be stabilized by the resistance opposing further extension.

Those skilled in the art will understand that the generally linear and serpentine travel of the member 20, by reversing the bias of the slider bars 37, 47 could be reversed, such that the member 20 is urged upwardly and then downwardly. Similarly, a single slider bar could be used to urge the member 20 into a serpentine, or other retracting configuration as will be explained. Finally, the use of three or more slider bars would fall within the scope of the invention.

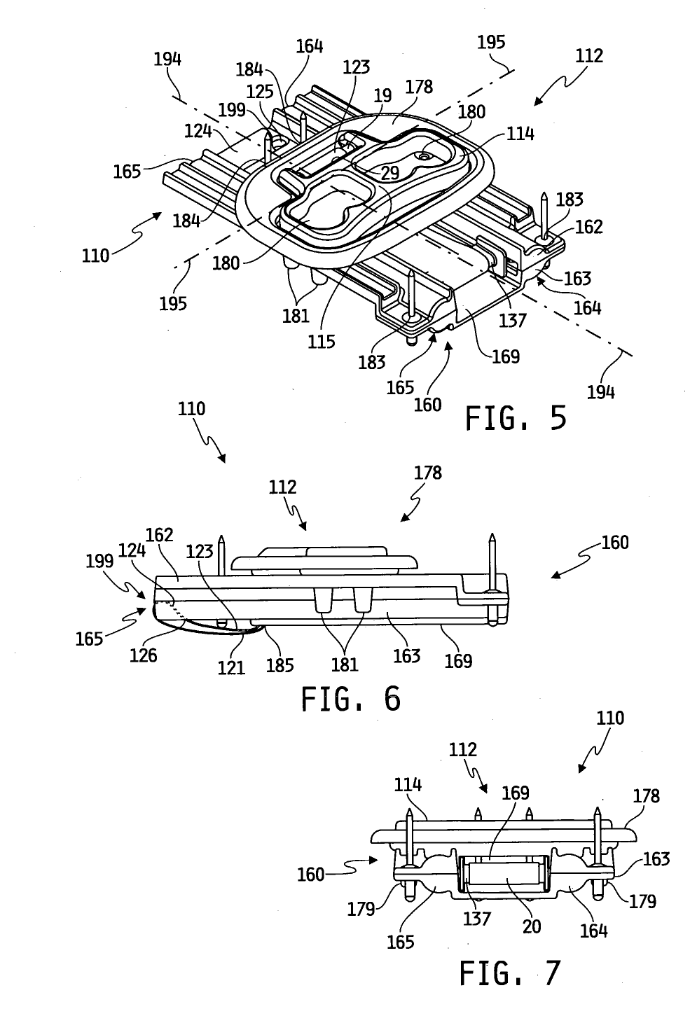

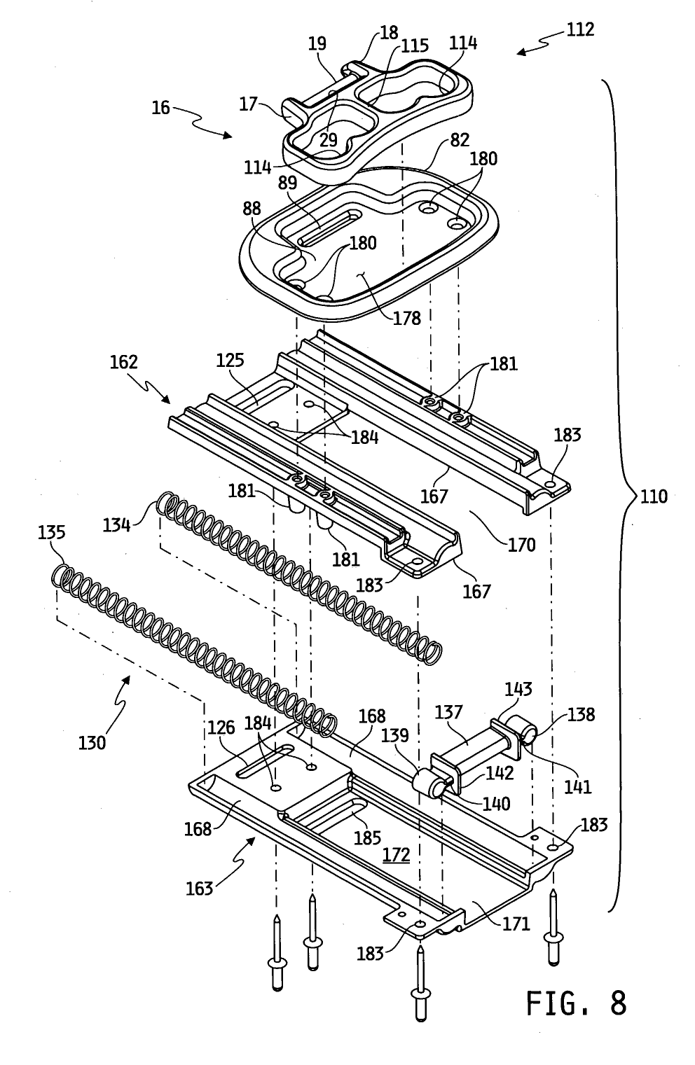

Referring to FIGS. 5-8, another illustrative embodiment is depicted. Stabilizing device or apparatus 110 is similar to stabilizing grab handle device 10 and like reference numerals will be used for like features and similar numerals will be used for similar features. Illustratively, stabilizing device 110 includes a handgrip 112, an extension member 20, a linear retraction mechanism 130, an housing 160, and a mounting plate 178. As best seen in FIGS. 5 and 8, handgrip 112 is generally rectangular in shape, and is a monolithic piece of injection molded plastic having a grip portion 114, an elongated neck portion 115, and a coupling portion 16. Coupling portion 16 is generally rectangular in shape and has an anchor bar 19 extending between and generally perpendicular to spaced-apart parallel ears 17 and 18 forming anchor aperture 29. It will be appreciated that although the grip portion 114, the neck portion 115 and the coupling portion 16 are fashioned from a single piece of injection molded plastic, it could be fashioned from other suitable materials and processes. For example, it could be die-cast from a suitable metal, such as aluminum or zinc. Similarly, it could be extruded. Other suitable materials include other metallic, nonmetallic, composite materials, and/or combinations thereof, including without limitation for example graphite or kevlar. Also, rather than being a monolithic member, the handgrip 112 could comprise a number of discrete component pieces coupled together in ways known to those in the art. For example, the anchor bar 19 could be coupled to the ears 17, 18 using screws (not shown).

Referring to FIGS. 5-8, housing 160 is generally rectangular in cross-section having a longitudinal axis 194 and a transverse axis 195, which is generally perpendicular to the longitudinal axis 194. Housing 160 includes generally parallel front 162 and rear 163 surfaces, which are made, illustratively, from injection molded plastic. Front surface 162 defines anchor aperture or anchorage 125, a pair of transversely spaced-apart and generally semi-cylindrical cavities 167, a center cavity 170, and a plurality of coupling apertures 181, 183 and 184. Rear surface 163 defines anchor aperture or anchorage 126, guide aperture 185, a pair of spaced-apart and generally semi-cylindrical cavities 168, a center cavity 171, and a plurality of coupling apertures 183 and 184. Center cavity 171 is generally closed by cover 172 of rear surface 163, and guide aperture 185 is defined through the cover 172. Although front surface 162 defines generally open center cavity 170, it could likewise have a cover portion similar to cover 172, and in such case could have a guide aperture formed through the front surface and generally aligned with guide aperture 89. Apertures 183 and 184 formed through top surface 162 are generally aligned with apertures 183 and 184 formed through bottom surface 163. Aligned apertures 183 and 184 in front and rear surfaces 162, 163 are configured to receive fasteners 179 such as for example, without limitation, screws, rivets, nuts and bolts, press-fit pins, tacks, and the like in order to fasten front and rear surfaces 162, 163 together. When front and rear surfaces 162, 163 are fastened together, upper cavities 167 are in communication with lower cavities 168 to define longitudinally extending, generally cylindrical, and transversely spaced apart bias guide channels 164 and 165. Similarly, cavities 170 and 171 align to define generally rectangular and longitudinally extending web guide channel 169, which is sandwiched between the spaced apart bias guide channels 164 and 165. So too, anchor apertures 125 and 126 are aligned when the front and rear surfaces 162, 163 are fastened together. As will be further explained below, extension member 20 generally lies and moves within guide channel 169.

Mounting plate 178 is illustratively a monolithic piece of injection molded plastic defining a storage cavity 88 bounded generally by lip or ridge 82 and having a guide aperture 89 and a plurality of fastening apertures 180 formed therethrough. The storage cavity 88 is configured to receive and nestle the handgrip 112 in a stowed or retracted position when the web 20 is fully retracted. Fastening apertures 180 are configured to receive fasteners, which, may be, for example without limitation, screws, rivets, nuts and bolts, press fits, and the like, to fasten the mounting plate 178 to top surface 162 via a plurality of aligned fastening apertures 181 (FIGS. 5 and 8). It will be appreciated, however, that the mounting plate 178 could be mounted directly to an intervening surface, such as for example a wall, of a vehicle or a building. The vehicle wall may be, for example, a side wall, or the wall 58 below the seat portion 56 of a seat 55. Whether in a building or a vehicle, the wall would have an aperture (not shown) generally aligned with aperture 89, and if front surface 165 had a cover (not shown, then with any guide aperture defined therethrough. Also, the mounting plate 178 could be mounted directly to the wall (not shown) or to both the wall and the front surface 162. However, it is also within the teaching of the disclosure to eliminate the front surface 162 and to attach rear surface 163 directly to a side of the wall (not shown) and the mounting plate to an opposite side of the wall (not shown) with the wall's guide aperture (not shown) being generally aligned with the guide aperture 89.

Referring to FIG. 8, the retraction mechanism 130 comprises a generally rectangular slider bar or member 137 and a pair of bias members, which, illustratively, are stainless steel springs 134 and 135. It will be appreciated that the springs could be fashioned out of suitably resilient materials other than stainless steel. The slider bar 137 illustratively is made of injection molded plastic and includes coupling portions 138 and 139 and respective guide portions 143 and 142, with extension pieces 141 and 140 sandwiched between the coupling 138, 139 and the guide 143, 142 portions. Coupling portions 138, 139 couple slider bar 137 to springs 134, 135 and lie within channels 164, 165 to dispose the slider bar or member 137 in and transversely across web guide cavity 169. The guide portions 142, 143 lie outside the respective channels 165, 164, but within the cavity 169. Channels 165, 164 are configured to receive, respectively, springs 135, 134 and coupling portions 139, 138. The springs 134, 135 are generally aligned with longitudinal axis 194 within their respective channels 165, 164. The coupling portions 138, 139, the extension portions 140, 141, and the guide portions 142, 143 are configured to align and guide the springs 134, 135 within their respective channels 164, 165 as will be apparent to those skilled in the art. The operation of the retraction mechanism 130 is generally similar to that of retraction mechanism 30, and will be more specifically described below.

Illustratively, flexible extension member 20 is movably coupled to the anchor bar 19. In the illustrative embodiments shown in FIGS. 5-13, extension member 20 is a flexible member having opposing end portions 121 and 123 and a mid-portion 22 therebetween. Extension member 20 may be a length of web belt, a length of line, a length of cable, a length of rope, a length of plastic, a length of cloth or other suitable flexible material. Handgrip 112 may move relative to extension member 20 about anchor bar's 19 longitudinal axis. Illustratively, end portions 121 and 123 are threaded through aperture 29 around opposing sides of anchor bar 19 such that the portions 121 and 123 double back toward each other and extend together away from the anchor bar 19 toward and through aperture 89, at least partially around slider bar 137, toward and through aperture 185. Thereafter, as best seen in FIG. 6, portion 121 extends over the end 199 of housing 160 and portion 123 extends upwardly through anchorage aperture 126 and through anchorage aperture 125 where it meets again with portion 121 and couples thereto generally at location 124 (FIG. 6) using, for example, stitching. The end portions 121, 123 may be coupled, or secured, using other couplings suitable to the particular type of flexible member in use. For example, without limitation, in the case of webbing, the ends 121, 123 may be coupled, in addition to or in lieu of using stitching, by snaps, hook and loops, cement, glue, melting or other suitable coupling. By way of further example, in the case of a rope or line, coupling may be accomplished through splicing or wrapping, and in the case of a cable, coupling may be accomplished through splicing, wrapping or welding, and the like. It will be appreciated that the coupling may take place at any suitable location other than at point 124, and rather than doubling back on itself, the member 20 may proceed and be coupled generally in accordance with the description attending device 10.

In operation, springs 134, 135 in their normal, at-rest or steady state position apply a retraction force to bias slider member or bar 137 in a retraction direction away from aperture 89, aperture 185 and anchorages 125, 126 and springs 134, 135. As noted with device 10, it will be appreciated that other suitable biasing structures, such as, without limitation, rubber bands, hydraulic pistons, pneumatic pistons and the like could be used to bias the slider member 137. Also, springs 134, 135 could be biased in the opposite direction, thus reversing the retraction direction. In the normal state, handgrip 112 is stowed within cavity 88 in the stowed position and the extension member 20 is generally within the housing 160 in cavity 169 in the retracted position. In this normal or steady state, flexible extension member 20 passes, as noted, generally underneath and at least partially around slider bar 137, which tends to urge member 20 downwardly away from anchorage end 199 (FIG. 6), and the flexible member 20 then continues upwardly within channel 169 toward aperture 185 as previously described. Thus, normally the bias members 134, 135 apply a retraction force to urge or bias the slider bar 137 and in turn to urge or draw in the retraction direction the extension member 20 into a retracted position generally defined by a substantially longitudinally oriented and serpentine path in order to retract or draw into the cavity 88 and to retain or stow therein the handgrip 112 in the stowed position.

When a user of the stabilizing grab handle device 110 applies to the handgrip 12 an extension force sufficient to overcome the bias force of the springs 134 and 135, in an extension direction away from the stabilizing device 110, as for example by pulling the gripping portion 114 outwardly, downwardly, or upwardly away from the mounting plate 178, the flexible extension member 20 acts against the spring-biased slider bar or member 137 to urge the slider bar upwardly toward and generally in line with guide aperture 89, which in turn straightens the flexible member 20 and pays it out of the housing 160 through aperture 89 into the extended position. As the extension member 20 straightens and urges the bar 137 along channels 164, 165, the springs 134, 135 compress in their respective channels 164, 165 and the bar 137 translates in a generally linear fashion within the channels 164, 165. Upon releasing the gripping portion 114, the springs 134, 135 return to their normal state and urge slider bar 137, and in turn the handgrip 110 and extension member 20, in the retraction direction back to the retracted and stowed positions. Short of releasing the handgrip 112, though, the outward force applied thereto may be eased to less than the bias forces of the springs 134, 135 such that the belt 20 will retract or be drawn in the retraction direction until such time as an outward force equal to or greater than the retraction bias force is reapplied to maintain or increase, respectively, the degree of extension. By applying an extension force generally equal to the retraction force, or greater than the retraction force such that the extension member 20 is fully extended, the user may be stabilized by the resistance opposing further extension.

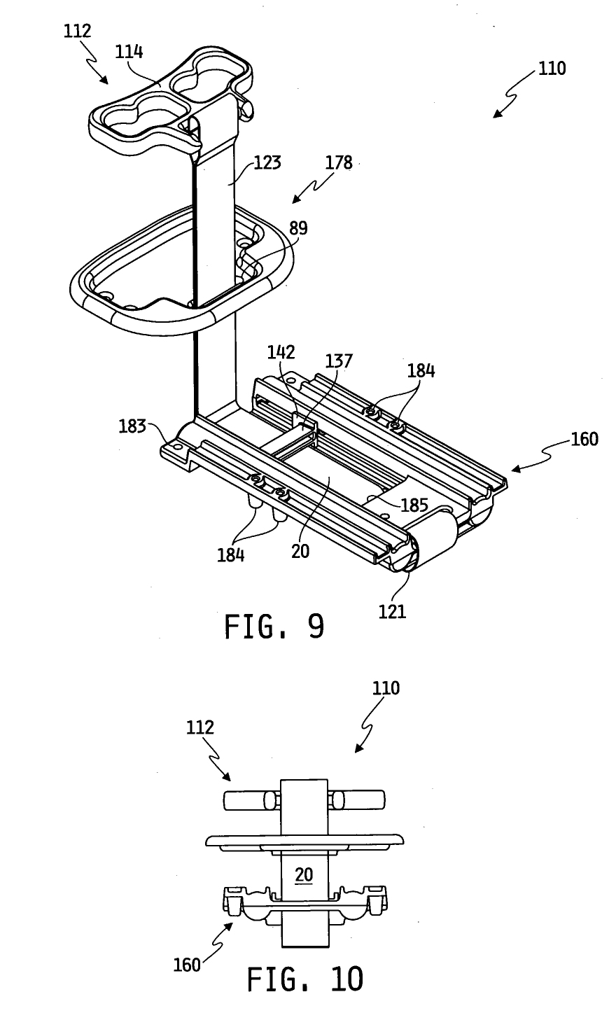

Those skilled in the art will understand that the travel of the member 20, by reversing the bias of the slider bars 137, could be reversed, such that the member 20 is urged upwardly and then downwardly. For example, the stabilizing device 110 could be mounted with anchorage end 199 oriented toward the user, or, alternatively, it could be mounted away from the user in an orientation 180 degrees out from the first-described mounting. Also, the device 110 could be mounted in a horizontal configuration. The use of additional springs and slider bars to urge the member 20 into a serpentine, or other retracting configuration would also fall within the scope of the invention. As best seen in FIGS. 9 and 10, the mounting plate 178 need not be aligned or mounted to the housing 160.

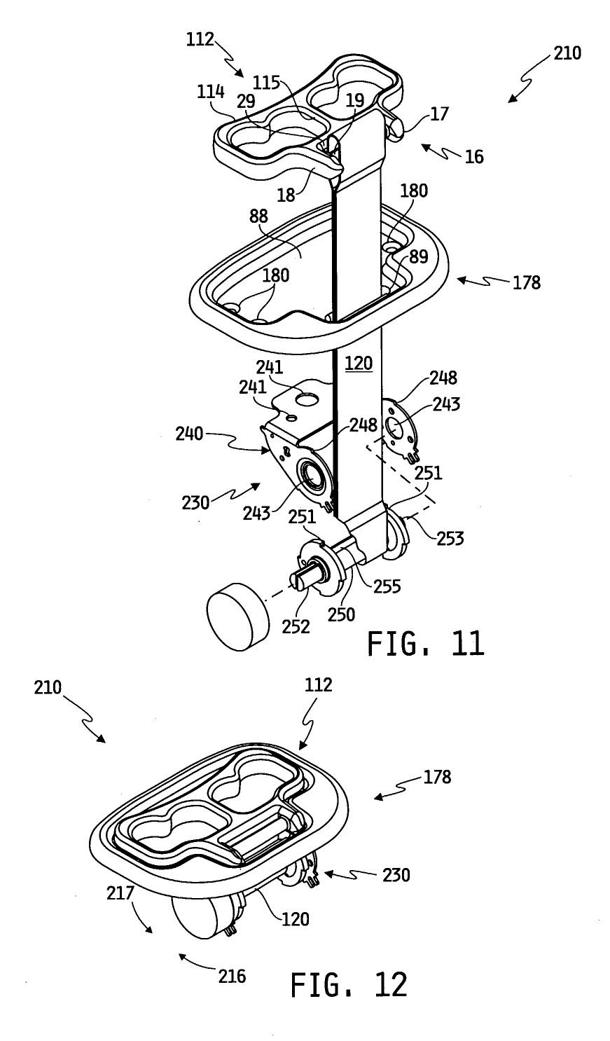

FIGS. 11 and 12 depict another illustrative embodiment of a stabilizing retractable grab handle device 210. Stabilizing device 210 illustratively comprises a handgrip assembly 112, a flexible member 120, a retraction mechanism 230 and a mounting plate 178. Handgrip assembly 112 and mounting plate 178 have substantially identical structures, alternate structures, compositions, alternate compositions, and operating characteristics as those described for stabilizing device 110 above and will therefore not be described again herewith. As with device 110, it will be appreciated that mounting plate 178 may attach directly to a wall of a vehicle or building, and may or may not also attach to retraction mechanism 230. Retraction mechanism 230 is a rotary device. One such rotary device is described in U.S. Pat. No. 6,109,200 to Rieger, the disclosure of which is expressly incorporated herein by reference.

Mechanism 230 comprises a frame portion 240 defining a plurality of mounting apertures 241 configured to mount the frame to the mounting plate 178 or to a wall, and spool mounting apertures 243 configured to receive and movably mount a spool 250 via mounting members 252, 253. Spool 250 and frame 240 illustratively are made from die cast zinc or aluminum or other suitable metallic, non-metallic or composite material as described above. Spool 250 includes an aperture 255 configured to receive and couple with the flexible member 120. The spool also has teeth or sprockets 251 which cooperate with stops 248 on frame 240 to allow for automatic locking positions of the flexible member 120, if desired. Any manner of rotating retraction devices may be suitable for use with the invention, including those available from Indiana Marine Corporation. Flexible member 120 is coupled to mounting bar 19 as described above in conjunction with device 110, extends downwardly through guide aperture 89 and couples to spool 250 at anchorage or anchor aperture 255. The mechanism also includes a spring (not shown), such as a for example a power spring, which normally tends to bias the spool in a retraction direction 216 to draw in and wrap the flexible member 120 in a retracted position around the spool 250 and in turn the handgrip 112 into its stowed position in cavity 88 as previously described above.

When a user of the stabilizing retractable grab handle device 210 applies to the handgrip 112 in the extension direction an extension force sufficient to overcome the retraction force of the power spring, as for example by pulling the gripping portion 114 outwardly away from the storage cavity 88, the bias spring yields to allow the flexible member to unwind or pay out from the spool 250 in an extension direction 217 opposite the retraction direction into an extended position. Upon releasing the gripping portion 114, the bias spring returns to its normal state and applies the retraction force to the spool 250 to draw in or retract the flexible member 20, and in turn the handgrip 110, in the retraction direction back to the retracted and stowed positions. Short of releasing the handgrip 112, though, the outward force applied thereto may be eased to less than the bias force of the spring (not shown) such that the belt 20 will retract or be drawn in the retraction direction until such time as an outward force equal to or greater than the retraction bias force is reapplied to maintain or increase, respectively, the degree of extension. By applying an extension force generally equal to the retraction force, or greater than the retraction force such that the extension member 20 is fully extended, the user may be stabilized by the resistance opposing further extension.

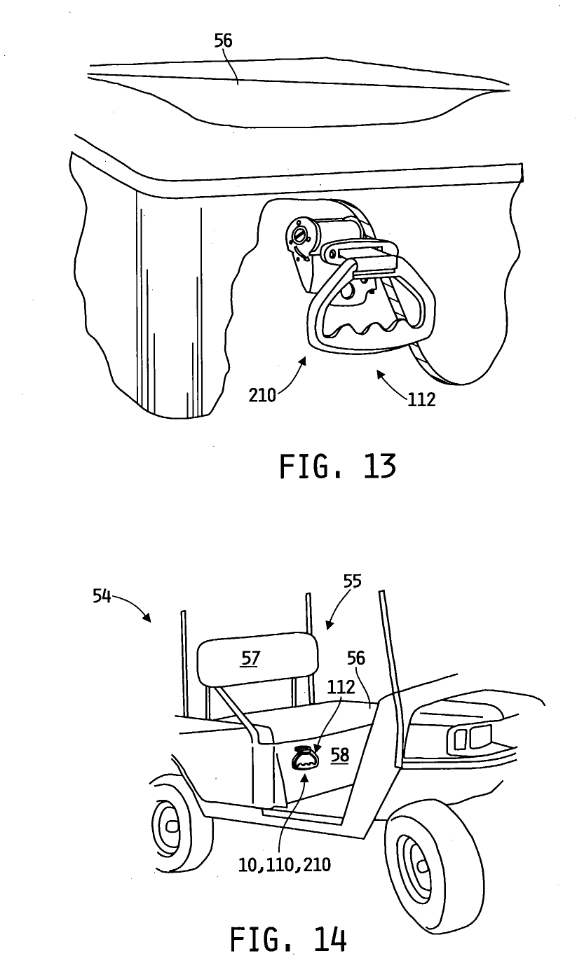

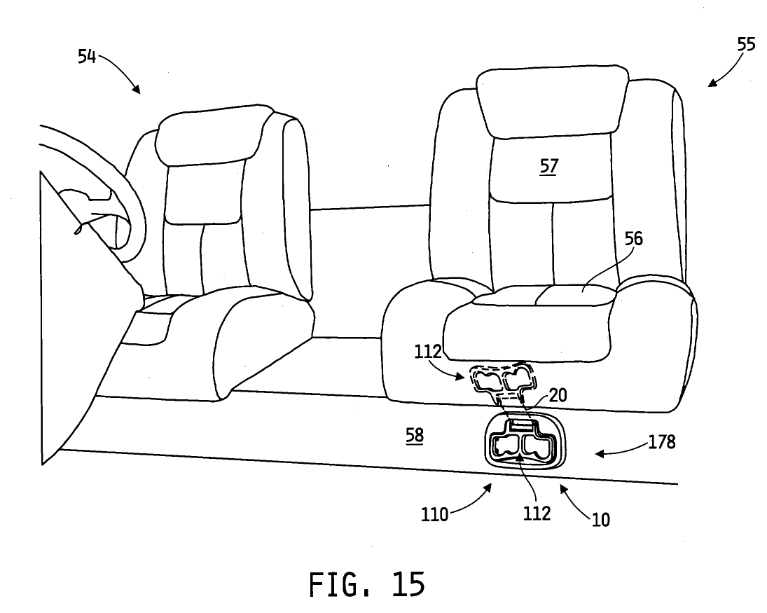

The retraction mechanisms 10, 110, 210 may be used to aid in stabilizing a person rising from a bed, chair or other piece of furniture, or while walking in a building, or traveling in any vehicle 54 such as for example without limitation in a golf cart (FIG. 14) or sport utility vehicle (FIG. 13), or dune buggy, or snow mobile, a water craft (FIG. 15) or other vehicle. It may also stabilize passengers standing in mass transit vehicles, such as trains, buses or planes, or passenger trying to rise from their seats in such vehicles. Thus, the face plate 178 and frame 240 of the stabilizing device 210 may be mounted to the wall of a vehicle 54, for example the side wall of the vehicle 54, or the wall of the seat 58 as depicted in FIGS. 13-15. So, too, as already described, stabilizing device 10, 110 may be mounted to the wall of a vehicle 54 or to the wall of a building, such as the wall of a hospital room, or a home bedroom.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected. Those skilled in the art will appreciate other myriad uses, which are intended to be covered.

What is claimed is:

1. A stabilizing device comprising:
a handgrip,
a retraction mechanism, and
a flexible member comprising a first opposing end coupled to the handgrip and a second opposing end extending at least partially about a portion of the retraction mechanism,
wherein the retraction mechanism normally exerts a retraction force on the flexible member to urge the flexible member in a retraction direction.

2. The stabilizing device of claim 1, wherein the retraction mechanism translates linearly to pay out the flexible member when an extension force acting opposite to and greater than the retraction force is applied to the handgrip to pay out the flexible member to an extended position.

3. The stabilizing device of claim 2, further comprising a housing having a front surface and a rear surface with the retraction mechanism mounted therebetween, wherein the flexible member extends from the handgrip, through a first guide aperture formed in the front surface, and wherein a second opposing end is coupled to an anchorage.

4. The stabilizing device of claim 3 further comprising a mounting plate defining a second guide aperture therethrough, the mounting plate configured to mount to one side of a wall and to said frame, wherein said frame is disposed on the other side of the wall.

5. The stabilizing device of claim 4, wherein the wall is integral to a vehicle.

6. The stabilizing device of claim 4, wherein the wall is integral to a building.

7. The stabilizing device of claim 4, wherein the retraction mechanism comprises:
a pair of bias members, and
a slider member,
wherein the slider member is disposed within and extends transversely between a pair of spaced apart and longitudinally extending guide channels formed by the front and rear surfaces and wherein one of the bias members is disposed within one of the channels and the other one of the bias members is disposed within the other of the channels, each bias member being in communication with the respective end of the slider member disposed in the same channel to normally urge the slider member in the retraction direction.

8. The stabilizing device of claim 7, wherein the bias members comprise springs.

9. The stabilizing device of claim 7, wherein the flexible member is a web.

10. The stabilizing device of claim 7, wherein the retraction mechanism further comprises a second pair of bias members disposed within a second pair of guide channels and tending normally to urge in a direction opposite from first said retraction direction a second slider member disposed within and transverse of the second pair of channels.

11. The stabilizing device of claim 1, further comprising a mounting plate defining a guide aperture therethrough, the mounting plate configured to mount to one side of a wall and to said frame, wherein said frame is disposed on the other side of the wall.

12. The stabilizing device of claim 11, wherein the wall is integral to a vehicle.

13. The stabilizing device of claim 12, further comprising a storage cavity for defined by the mounting plate and sized to nestle the handgrip when in a stowed position when the flexible member is fully retracted, and
wherein the retraction mechanism comprises a retractor that rotates to pay out the extension member when an extension force acting opposite to and greater than the retraction force is applied to the handgrip to move the handgrip from the stowed position and to pay out the flexible member to an extended position.

14. A device for stabilizing a user, the stabilizing device comprising:
a housing comprising
a front surface defining a first guide aperture therethrough and a front pair of spaced apart and longitudinally extending cavities,
a rear surface coupled to the front surface and defining an anchorage and a rear pair of spaced and longitudinally extending cavities, wherein the front pair of cavities communicate with the rear pair of cavities to form a first guide channel and a second guide channel transversely spaced apart from the first guide channel when the front and rear surfaces are coupled together,
a slider member comprising a first coupling end disposed within the first guide channel and a second coupling end disposed within the second guide channel with the bar extending transversely between the guide channels and movable longitudinally therein,
a first bias member disposed within the first guide channel and coupled to the first coupling end,
a second bias member disposed within the second guide channel and coupled to the second coupling end,
a handle,
a flexible member comprising first and second opposing ends, the first opposing end being coupled to the handgrip and the second opposing end proceeding through the first guide aperture, at least partially around the slider member and being coupled to the anchor aperture,
wherein the bias members normally tend to urge the slider member away from the anchorage in order to draw the flexible member into the housing in a retraction direction and the handle into a stowed position, and
wherein a user may overcome the normal tendency by pulling the handle outwardly away from the front surface, thereby withdrawing the flexible member from the housing in an extension direction opposite the retraction direction.

15. The stabilizing device of claim 14, further comprising a face plate mounted to the housing and defining a second guide aperture therethrough, and
a storage cavity to nestle the handle in the normally stowed position,
wherein the flexible member extends through the second guide aperture and at least partially about the slider member, the second end being coupled to the anchorage.

16. The stabilizing device of claim 15, wherein the device is mounted to a vehicle.

17. The stabilizing device of claim 15, wherein the device is mounted to a wall of a building.

18. A device for stabilizing a user, the device comprising:
a handle,
a flexible member comprising first and second opposing ends, the first opposing end being coupled to the handle,
a mounting plate defining a first guide aperture therethrough and a storage cavity shaped to receive therein the handle,
a retractor comprising:
a frame,
a spool mounted to the frame,
a bias member disposed between the frame and the spool, wherein the second opposing end proceeds away from the handle, through the guide aperture and at least partially around and coupled to the spool,
wherein the bias member normally tends to rotate the spool relative to the frame in a retraction direction to draw in and wrap the flexible member about the spool and to seat the handle into the storage cavity, but
wherein said bias member is yieldable to a force opposite to and greater than the normal force of the bias member as when a user pulls the handle in an extension direction opposite to the retraction direction to pay out the flexible member from the spool, and
wherein the frame is mounted to one side of a wall, and the mounting plate is mounted to the opposite side of the wall, with the flexible member proceeding through a second guide aperture defined through the wall.

19. The stabilizing device of claim 18, wherein the wall is the wall of a building.

20. The stabilizing device of claim 18, wherein the wall is the wall of a vehicle.
